(19) United States
(12) Patent Application Publication
(10) Pub. No.: US 2023/0006483 A1
(43) Pub. Date: Jan. 5, 2023

(54) STATOR OF A ROTATING ELECTRICAL MACHINE, ROTATING ELECTRICAL MACHINE AND DRIVE UNIT HAVING A MACHINE OF THIS TYPE

(71) Applicant: Pendix GmbH, Zwickau (DE)

(72) Inventors: Sebastian FETHKE, Zwickau (DE); Frank MODES, Zwickau (DE)

(21) Appl. No.: 17/778,341

(22) PCT Filed: Dec. 7, 2020
(86) PCT No.: PCT/DE2020/200109

§ 371 Date: May 19, 2022

(30) Foreign Application Priority Data
Dec. 6, 2019 (DE) 10 2019 133 409.8

(51) Int. Cl. H02K 1/16; H02K 1/2791

(52) U.S. Cl. CPC H02K 1/165; H02K 1/2791; H02K 2201/03; H02K 2201/15

(57) ABSTRACT

The invention relates to a rotating electrical machine with an external rotor having a permanent magnet assembly. The invention also relates to a stator of a rotating electric machine of this type. In order to increase the performance and/or reduce the weight and/or installation space, a permanent magnet assembly is provided having segments with changing magnetisation directions in such a way that the magnetic flow is increased over the inner casing surface of the hollow cylinder facing the stator and therefore in the air gap and it is reduced over the opposing outer casing surface. For the stator of a drive unit of this type, stator teeth of a trapezoidal shape are proposed, having an outwardly increasing tooth width, wherein a respective coil winding is arranged on the stator teeth.

The invention relates generally to a rotating electrical machine in which a conversion of electrical power into mechanical power (electric motor) or of mechanical power into electrical power (electric generator) takes place and which has a rotor and stator as essential components. The invention also relates to a stator of such a rotating electrical machine.

The invention relates in particular to an electric motor or a generator of such a drive unit, which is used for the locomotion of motorized vehicles of various types. In particular, it relates to a drive unit with an electric motor embodied as a radial flux machine, the rotor of which has a permanent magnet arrangement.

The invention also relates to an electric generator, the stator of which has the induction coils for generating a magnetic field. The excitation can take place by means of permanent magnets or electromagnets arranged in the rotor, wherein the former can already be used also for generators in the megawatt range as the development of high-power magnets progresses and continues to gain in importance.

The invention additionally relates to a drive unit which is equipped with a rotating electrical machine according to the invention.

A drive unit for the locomotion of a motorized vehicle is understood here to mean those devices which serve to transmit power and for this purpose perform or support a rotation on the output side. The power transmission is realized directly, for example by means of single-wheel drive or the like, or indirectly, for example by means of suitable transmission means such as traction drive, cardan shaft or the like. Such drive units are known for transporting people or objects, for example, for various land vehicles, including muscle-powered means of locomotion, as electric drives or auxiliary drives. They are currently used for various electric vehicles, such as bicycles, pedal scooters, Segways or the like. A controlled combination of multiple drive units for larger vehicles is also known. With advancing development and diversification of locomotion, further fields of application may arise.

Such electric motors can be of internal rotor or external rotor configuration. They have a stator which is connected to a frame or housing or the like that is fixed relative to the rotor. The stator is formed as a substantially round stator body made of sheet metal, considered from the inner or outer contour. The stator has circumferentially arranged stator teeth with stator slots in between, which form poles for receiving coil windings, routinely made of copper. The stator teeth are interconnected by a stator flux guide. The term “substantially” includes such contours which, for example, are formed by a polygonal chain because of the shape of the stator teeth, wherein the vertices of the stator teeth are the plurality of key points of the polygonal chain and the round contour is perceived by the circle of the polygon. The polygon of such a stator is routinely a regular polygon with equal side lengths and equal interior angles.

In the case of the external rotor configuration, the rotor of the electric motor is arranged coaxially with the stator in such a way that the rotor surrounds the stator circumferentially and can rotate about the stator. The (possibly notional) inner lateral face of the rotor opposite the stator teeth has a permanent magnet arrangement such that an annular air gap, referred to as a working gap, is formed between the inner lateral face of the permanent magnet arrangement and the (possibly notional) outer lateral face of the stator. In such a configuration, the stator is often fixedly mounted on an axle or hub, while the rotor assembly is rotatably mounted.

The position of the working gap and, directly connected with this, its effective radius, for example the center radius, is a parameter which has a significant influence on the torque of the machine. Another parameter is the magnetic flux of the permanent magnet arrangement and the stator winding. The latter is characterized in particular by the degree to which the stator slots are filled with the winding, wherein the manufacture of the winding and density thereof pose particular challenges.

The basic design of an electric generator is comparable to that of an electric motor due to the same basic physical principle, electromagnetic induction, which is why both machines are collectively referred to as rotating electrical machines and why a majority of the parameters affecting performance apply to both types of machines.

The invention is based on the object of specifying a rotating electrical machine with which the degree of filling and the mechanical or electrical power that can be generated can be increased compared to comparable machines, and at the same time the required installation space and the material costs can be reduced or at least kept the same.

With reference to a drive unit with an electric motor with radial flux configuration, higher torques and/or smaller machines in particular are to be achievable compared to the prior art. This is particularly desirable for the external rotor configuration, which is used for the above-mentioned drives and auxiliary drives for the transport of people and goods.

The object is achieved by a stator as claimed in claim 1, which can be used in a rotating electrical machine, i.e., in an electric motor or a generator. The object is also achieved by a rotating electrical machine according to claim 9 and by a drive unit using such a machine according to claim 13. The dependent claims related to these claims describe advantageous embodiments of the subjects of the independent claims.

The features used to realize the invention are described below. The person skilled in the art will combine these with each other in different embodiments, as far as this seems reasonable and suitable for a particular application.

In accordance with the invention, the stator teeth and stator slots have geometries such that the stator teeth have a trapezoidal shape with an outwardly increasing tooth width, or such that the stator slots have parallel flanks. A combination of both features is also possible. For this purpose, the shape of the stator teeth can be selected such that the stator slots are parallel slots so that they can be filled to the maximum by the windings of the two adjacent coils in each case.

A separate coil winding of an induction coil is arranged on each of the stator teeth.

The separate coil windings permit an optimization of the degree of filling of the stator slots and reduce the manufacturing effort compared with the known stator windings. In addition, the width of the stator teeth, which increases outwardly at least in some sections, makes it possible to fix the coil winding to a certain extent.

A fixability of the stator winding with an optimum filling level can be achieved, for example, if the stator tooth has the largest tooth width at its outer end, hereinafter also referred to as the fixing dimension. For example, the tooth width can increase steadily starting from its inner end towards the outer end. Alternatively, the increase may first occur at a distance from its inner end and/or may be discontinuous, wherein a trapezoidal shape may be formed in some sections. In this embodiment, too, it is advantageous if at least the outer portion has the trapezoidal shape and the outer end has the fixing dimension.

According to one embodiment of the invention, the coil windings are formed by means of separate coils having a coil former and their own coil winding.

Depending on the design of the stator teeth, for example the difference in width of the trapezoid of the stator teeth and the design of the coil former, its shape can correspond to the trapezoidal shape of the stator teeth.

The coil formers can be in the shape of a prism or cylinder. They are designed in such a way that the coils can be mounted on the stator teeth by the stator teeth extending fully or partially into the coil former. For this purpose, each coil former has a coil former lying between the bottom and top face and also a passage running through at least the coil former and the bottom face. A coil winding is arranged on the lateral face of the coil former.

The passage in the coil former can, for example, have a square cross-section. Other designs of the cross-section are also possible, such as circular or n-sided with n as an element of the natural numbers and equal to or greater than 3. According to one embodiment, the bottom and top faces of the coil former can be formed by an inner and outer coil flange. These can have a shape adapted to the passage in the coil former or deviating therefrom.

Here, a coil flange is to be understood to be a plate-shaped body which adjoins the coil former and projects circumferentially beyond its lateral faces. Thus, a coil flange can represent a limitation for the coil winding. At least the inner coil flange has a passage corresponding to the passage of the coil former. Optionally, both coil flanges may have such a passage. With a rectangular shape of at least the outer coil flanges of the stator, the production of an almost closed outer lateral face of the stator is possible.

The terms “outer” and “inner” relate to the axis of the stator, so that outer components have a greater radial distance from the axis and inner components have a smaller radial distance.

According to one embodiment, the coil formers can be formed from plastic, wherein it has proven to be advantageous, in comparison to the mushroom-shaped stator teeth of the laminated core known from the prior art, that the coil formers according to the invention have no influence or at least no significant influence on the cogging torque.

In addition, the design of the coil formers made of plastic can support the fitting process. This is particularly the case if the coil former is designed to be elastically deformable, either completely or in some sections, so that at least its cross-sectional area can be deformed. In this way, the coil former can be pressed in one direction, thus increasing the extension of the passage in the other direction, which is at right angles thereto. In this way, the coil former can be easily guided onto the trapezoidal stator tooth and fixed thereon by relieving the load.

In a further embodiment of the invention, the stator slots are designed to be open to the outside and thus to the external rotor and the intermediate air gap.

This means that the slots are not closed by the laminated core or other components of the stator, except for the coils as described below, for example to fix the windings. In this way, the installation space of the rotor can be further reduced and the efficiency of an electrical machine in which the stator is used can be improved.

The individual coils can be prefabricated separately and fixed to the stator teeth just by being fitted on. The latter is also supported or simplified by the open stator slots and described trapezoidal shape of the stator teeth. Supplementary holding means for consistently holding the coils in their position can be arranged, for example depending on the speed to be realized.

By means of the embodiments according to the invention, the installation space and/or the weight of the stator can be reduced. In addition or alternatively, an increase in the achievable torques of the electric motor is thus possible.

The object of the invention is additionally achieved by a rotating electrical machine according to claim 9. As described above with respect to the prior art, this includes both an electric motor and an electric generator.

Such a rotating electrical machine comprises a rotatably mounted rotor, which has a hollow-cylindrical permanent magnet arrangement formed from a plurality of segments. The permanent magnet arrangement routinely has such a shape that its inner and outer diameters are significantly larger than the height of the hollow cylinder of the magnet arrangement.

The segments of the permanent magnet arrangement are arranged so that their directions of magnetization change from segment to segment in defined steps. The change takes place in such a way that the magnetic flux is increased over the inner lateral face of the hollow cylinder facing the stator and thus in the air gap, and decreased over the opposite outer lateral face. Such an influence on the magnetic flux is achieved by rotating each of the segments about an axis of the particular segment lying parallel to the lateral face in the same direction of rotation by a defined angle in each case, for example 90°. As the segments are rotated in each case through 90°, the magnetic pole changes from one segment to the next at the outer lateral face of the permanent magnet arrangement facing away from the air gap and remains the same at the inner lateral face of the permanent magnet arrangement. Also smaller and larger angles, preferably in the range of 45°-90°, are possible as far as the described one-sided intensification in the air gap can be realized. The angles in question can be determined by tests or simulations.

The rotating electrical machine further comprises a stator, which is connected to a machine component that is stationary relative to the rotor. The connection between stator and the component in question can be made directly or via further components. The stator has at least one stator winding, by means of which a magnetic field can be generated in the air gap, described below, between the rotor and the stator (electric motor) or in which current can be generated by means of electromagnetic induction (generator). The stator has one of the previously described embodiments.

The rotor is arranged coaxially with the stator in such a way that the rotor circumferentially surrounds the stator, forming an annular air gap between the rotor and the stator, and the rotor can rotate around the stator.

The above-described rotation of the magnetic poles from segment to segment is preferably performed in each case through 90°, as explained in more detail below in the exemplary embodiment. In this way, poles of the same type are adjacent to each other on the inner lateral face of the rotor and poles of the opposite type are adjacent to each other on the outer lateral face. As a result, the magnetic flux is significantly intensified in front of the inner lateral face and significantly reduced at the outer lateral face of the magnets of the rotor.

Reducing the magnetic flux on the outer lateral face of the rotor allows the flux ring on the rotor to be reduced or eliminated, thereby reducing the installation space of the rotor. Alternatively or additionally, a ring encompassing the rotor can be optimized for holding and stabilizing the rotor.

According to one embodiment of the invention, the rotating electrical machine can be a drive unit which is designed for a motorized vehicle which serves to move people and/or goods and comprises an electric motor. According to the current state of development, land vehicles in particular can be considered as vehicles. Such drives, however, can also be used for watercraft and aircraft, for example in model making.

In such an application, the stator is connectable to the drive unit and/or to a component of the vehicle that is stationary relative to the rotor.

By way of example, but not in a limiting manner, an electric bicycle auxiliary drive is mentioned as an application of the drive unit according to the invention. In this case, the stator is connected to the bicycle frame and the rotor to the rotatable part of the bottom bracket.

The increase in magnetic flux in the air gap between the rotor and the stator, which can be achieved with the permanent magnet arrangement as described above, allows a higher torque of the rotating electrical machine to be achieved, this being generated by the interaction of the two magnetic fields in the air gap. This effect can also be used to increase the power of a drive unit using such an electrical machine and/or to reduce the installation space or weight of the electrical machine and thus also of the drive unit.

When using a stator according to one of the previously described embodiments, the improvement or optimization of performance and/or installation space and weight can be continued, since the degree of filling of the stator slots, which can be increased with the stator teeth and fitted coils, has a comparable effect on the magnetic field that can be generated with the stator and thus on the performance of the machine.

The same applies to an optional design of the segments of the permanent magnet arrangement in which the segment types differentiated according to their direction of magnetization have different circumferential dimensions. The term “circumferential” dimension means the length of the magnet segments which characterizes the share of each particular segment in the total circumference of the permanent magnet arrangement. This dimension can be used to further optimize the running and performance of the rotor. If, for example, those segments of which the magnetic poles are radially oriented are made wider than those with a rotated magnetic orientation, the displacement of the magnetic flux in the direction of the stator and thus the magnetic flux in the air gap can be further increased.

A drive unit according to the invention of a motorized vehicle for moving people and/or goods comprises either an electrical machine according to the invention formed as an electric motor or as a generator according to the above description, since the design according to the invention can be used for both the electric motor and the generator. A combination of both is also possible, for example in a series hybrid drive, in which the energy obtained with the generator is supplied to the electric motor, for example but not restrictively via an accumulator. The electric motor or generator of such a drive concept according to the invention can alternatively also be combined with a generator or electric motor of other designs. Such a series hybrid drive can be used, for example, but not restrictively, for a bicycle.

The invention will be explained in more detail below, by way of example but without limitation, with reference to drawings of a drive unit. The associated figures show in

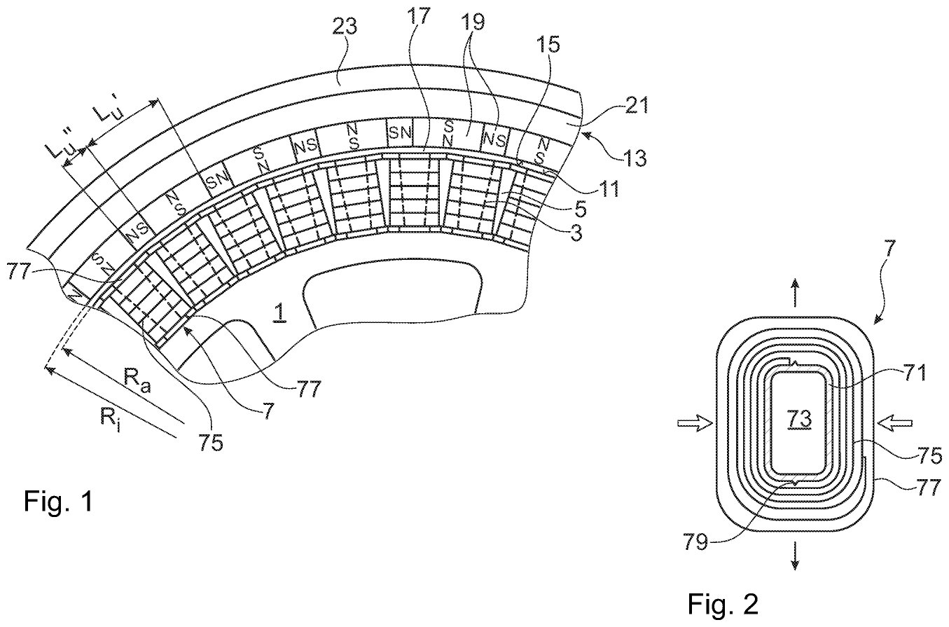

FIG. 1 a segment of the rotor-stator unit of the drive unit according to the invention in plan view, and

FIG. 2 a coil which can be fitted to a stator tooth, in a sectional view.

The devices according to the invention are shown merely schematically to the extent necessary to explain the invention. It is not claimed that these are complete or to scale.

The segment in FIG. 1 shows part of a stator 1, which has trapezoidal stator teeth 3 and rectangular stator slots 5 (shown by dashed lines). A coil 7 is fitted to each stator tooth. The coils 7 are constructed and arranged in such a way that the coil flanges 77, directly adjacent to each other, form the outer lateral face 11 of the stator 1 with the outer radius Rₐ of the stator 1.

Concentric to the stator 1, the rotor 13 is arranged in such a way that an air gap 17 (also referred to as a working gap) exists between the outer lateral face 11 of the stator 1 and the inner lateral face 15 of the rotor 13. The width of the air gap 17 is determined by the circumferentially uniform difference between the inner radius Rᵢ of the inner lateral face 15 of the rotor 13 and the outer radius Rₐ of the outer lateral face 11 of the stator 1.

The rotor 13 comprises a permanent magnet assembly formed from a plurality of permanent magnets 19. The magnets 19 each have a direction of magnetization represented in FIG. 1 by north pole “N and south pole “S”. The magnets 19 are formed and arranged in such a way, that their direction of magnetization always rotates through 90° from one magnet to the next, adjacent magnet. The circumferential length Lᵤ′ of those magnets 19 which have a radial direction of magnetization is a multiple of the circumferential length Lᵤ″ of the magnets 19 with a direction of magnetization at right angles thereto.

The magnets 19 are mounted on a ring 21, which serves as a flux ring of the rotor 13 and optionally at the same time for stabilization. The rotor 13 and stator 1 are enclosed in a housing 23, of which only the annular closure is visible.

FIG. 2 shows a coil 7 which has a coil former 71 with a rectangular cross-section and a central passage 73. A multi-layer, dense coil winding 75 is formed on the coil former 71. The coil winding 75, viewed radially, is delimited on the inside and outside (FIG. 1) in each case by a coil flange 77.

The coil former 71 consists of an electrically insulating plastic and has flexible portions 79 on two opposite walls (shown by a kink in the wall). To fit the coils 7 onto the stator teeth 3, the distance between these two walls can be increased by applying a compressive force (shown by two arrows) to the other two walls. The pressing causes the flexible portions 79 to deform outwardly (shown by outwardly directed arrows), thus increasing the internal cross-section in that direction so that the coil can be pushed over the outer, larger cross-section of a trapezoidal stator tooth 3. When pressing is complete, the coil former 7 resumes its original form and is thus fixed on the stator tooth 3.

1-15. (canceled)

16. A stator designed for use in an electric motor with an external rotor, the stator comprising:
a stator body formed from at least one metal sheet, the outer contour of which stator body has a substantially round shape, wherein the stator body has stator teeth circumferentially arranged with stator slots located between them, the stator teeth are connected to one another by a stator flux guide, wherein coil windings run through the stator slots, and wherein:
the stator teeth have a trapezoidal shape with a tooth width that increases outwardly; and/or
the stator slots have parallel flanks and a coil winding of the coil windings is arranged on each of the stator teeth.

17. The stator of claim 16, wherein the coil windings are formed of separate coils, and wherein the separate coils each comprise a bottom face, a top face, a lateral face, and a coil former with a passage that runs between the bottom face and the top face and that carries a coil winding wound on the lateral face.

18. The stator of claim 17, wherein the bottom faces and the top faces of the coils are formed by an inner coil flange and an outer coil flange.

19. The stator of claim 18, wherein the outer coil flanges are rectangular in shape to form an outer lateral face of the stator.

20. The stator of claim 17, wherein the coil formers consist of plastic.

21. The stator of claim 17, wherein the coil formers are elastically deformable at least in some sections in such a way that their cross sectional areas can be deformed.

22. The stator of claim 17, wherein the separate coils are fitted onto the stator teeth.

23. The stator of claim 16, wherein the stator slots are open to the outside.

24. A rotating electrical machine, comprising:
a rotatably mounted rotor having a hollow cylindrical permanent magnet arrangement formed from a plurality of segments; and
the stator of claim 16 connected to a component of the rotating electrical machine that is fixed relative to the rotatably mounted rotor;
wherein the rotatably mounted rotor is arranged coaxially with the stator so that the rotatably mounted rotor circumferentially surrounds the stator and forms an annular air gap between the rotatably mounted rotor and the stator and so that the rotor can rotate about the stator;
wherein the stator has induction coils to form a magnetic field in the air gap;
wherein directions of magnetization of the segments of the permanent magnet arrangement differ from segment to segment in such a way that magnetic flux is increased over an inner lateral face of a hollow cylinder facing the stator and thus in the air gap, and is reduced over an opposite, outer lateral face of the hollow cylinder.

25. The rotating electrical machine of claim 24, wherein the rotating electrical machine is an electric motor or a generator of a drive unit of a motorized vehicle for moving people and/or goods, wherein the stator is connected to a component of the drive unit which is fixed relative to the rotatably mounted rotor or is connectable to a component of the vehicle which is fixed relative to the rotatably mounted rotor.

26. The rotating electrical machine of claim 24, wherein the segments of the permanent magnet arrangement have circumferential dimensions differing from one another.

27. The rotating electrical machine of claim 26, wherein segments of the permanent magnet arrangement of which the direction of magnetization is radially oriented have a largest circumferential dimension.

28. The rotating electrical machine of claim 24, wherein the permanent magnet arrangement is enclosed by a concentric retaining ring directly adjacent to the permanent magnet arrangement.

29. A drive unit of a motorized vehicle for moving people and/or goods, the drive unit comprising the rotating electrical machine of claim 24.

30. The drive unit of claim 29, wherein the rotating electrical machine is a generator of the drive unit, and wherein the drive unit further comprises a coupling in series to the generator as a front serial member and an electric motor as a rear serial member.
